(19) United States
(12) Patent Application Publication
(10) Pub. No.: US 2023/0335023 A1
(43) Pub. Date: Oct. 19, 2023

(54) Towel-Spinning Device

(71) Applicant: Dennis Jackson, Saint Charles, MO (US)

(72) Inventor: Dennis Jackson, Saint Charles, MO (US)

(21) Appl. No.: 18/174,034

(22) Filed: Feb. 24, 2023

Related U.S. Application Data
(60) Provisional application No. 63/330,926, filed on Apr. 14, 2022.

(51) Int. Cl. G09F 17/00; G09F 21/02

(52) U.S. Cl. CPC G09F 17/00; G09F 21/02; G09F 2017/005

(57) ABSTRACT

The present invention relates to a towel-spinning device for spinning a rally towel at a sporting event. The device is primarily comprised of a body with a first end having at least one removable end cap and a second end that is used as a handle. At least one towel (i.e., a rally towel) can be secured to the device by placing the towel into an opening of the first end and inserting the end cap back into the opening.

### CROSS-REFERENCE TO RELATED APPLICATION

The present application claims priority to, and the benefit of, U.S. Provisional Application No. 63/330,926, which was filed on Apr. 14, 2022, and is incorporated herein by reference in its entirety.

### FIELD OF THE INVENTION

The present invention relates generally to the field of sporting event fan devices. More specifically, the present invention relates to a towel-spinning device primarily comprised of a body with a first end having at least one removable end cap and a second end that is used as a handle. At least one towel (i.e., a rally towel) can be secured to the device by placing the towel into an opening of the first end and inserting the end cap back into the opening. Accordingly, the present disclosure makes specific reference thereto. Nonetheless, it is to be appreciated that aspects of the present invention are also equally applicable to other like applications, devices, and methods of manufacture.

### BACKGROUND

Fans at sporting events often twirl and spin “rally towels”. To do so, a user grasps a corner of the towel and attempts to spin it in a circular motion in the air. However, during this process the towel can bunch up and knot. In addition, consistently spinning a rally towel throughout a game can cause significant discomfort and fatigue to the wrist, arm, and shoulder of a fan. Furthermore, some individuals with arthritis or limited strength may have difficulty gripping a rally towel during use.

Therefore, there exists a long-felt need in the art for a device that can be used to spin a rally towel. More specifically, there exists a long-felt need in the art for a towel-spinning device that allows a user to easily spin a rally towel. There also exists a long-felt need in the art for a towel-spinning device that allows a user to easily spin a rally towel without allowing the towel to bunch up or become knotted during use. In addition, there exists a long-felt need in the art for a towel-spinning device that allows a user to spin a rally towel without discomfort and fatigue to the wrist, arm, and shoulder of the user. Finally, there exists a long-felt need in the art for a towel-spinning device that allows a user to spin a rally towel while firmly securing the rally towel.

The subject matter disclosed and claimed herein, in one embodiment thereof, comprises a towel-spinning device. The device is primarily comprised of a body with a first end having at least one removable end cap and a second end that is used as a handle. At least one towel (i.e., a rally towel) can be secured to the device by placing the towel into an opening of the first end and inserting the end cap back into the opening. In alternative embodiments, the towel may be secured to the body by being fed through at least two openings or by being secured to a fastener.

In this manner, the towel-spinning device of the present invention accomplishes all the foregoing objectives and provides a towel-spinning device that allows a user to easily spin a rally towel without allowing the towel to bunch up or become knotted during use. In addition, the device allows a user to do so without discomfort and fatigue to the wrist, arm, and shoulder of the user. Finally, the device allows a user to spin a rally towel while firmly securing the rally towel.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a towel-spinning device. The device is primarily comprised of a first end comprised of at least one removable end cap and a second end used as a handle. The body is preferably cylindrical in shape. However, the body may have any shape including, but not limited to, a shape that may relate to a team, a mascot, an item, an object, a character, a piece of sporting equipment, etc.

The first end of the body is comprised of an opening that receives at least one end cap. The end cap is comprised of a round top surface and a round side wall that can be received by the opening. The top surface of the end cap may be comprised of at least one decorative structure that can include, but is not limited to, a team logo, a team mascot, an item, an object, a character, a person, a player, a coach, an owner, a piece of sporting equipment, a logo, a brand, etc. In one embodiment, the structure is comprised of at least one light source that is preferably an LED light that may illuminate any color and in any illumination pattern.

The second end of the body is used as a handle to hold the device. In one embodiment, the second end is comprised of at least one grip area. The grip area may be comprised of a raised or recessed texture that improves a user's ability to grip the body.

The device may also be comprised of at least one towel that is preferably rectangular in shape. The towel may be made from any fabric material known in the art. The towel may also be comprised of at least one indicia such as, but not limited to, a team logo, a team mascot, an item, an object, a character, a person, a player, a coach, an owner, a piece of sporting equipment, a logo, a brand, a word, a number, etc.

The device is also comprised of a method of use. First, the end cap is removed from the opening. Then, a portion of the towel is inserted into the opening. Next, the end cap can be re-inserted into the opening to secure the towel to the body by pinning the towel within the body via the end cap. Then, a user can grasp the second end and twirl the device, preferably at a sporting event.

Accordingly, the towel-spinning device of the present invention is particularly advantageous as it provides a towel-spinning device that allows a user to easily spin a rally towel without allowing the towel to bunch up or become knotted during use. In addition, the device allows a user to do so without discomfort and fatigue to the wrist, arm, and shoulder of the user. Finally, the device allows a user to spin a rally towel while firmly securing the rally towel. In this manner, the towel-spinning device overcomes the limitations of existing methods of spinning and using rally towels known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a towel-spinning device of the present invention in accordance with the disclosed architecture;

FIG. 2 illustrates an enhanced perspective view of a first end of one potential embodiment of a towel-spinning device of the present invention in accordance with the disclosed architecture;

FIG. 3 illustrates an enhanced perspective view of a first end of one potential embodiment of a towel-spinning device of the present invention in accordance with the disclosed architecture;

FIG. 4 illustrates an enhanced perspective view of a first end of one potential embodiment of a towel-spinning device of the present invention in accordance with the disclosed architecture;

FIG. 5 illustrates a flowchart of a method of using one potential embodiment of a towel-spinning device of the present invention in accordance with the disclosed architecture; and

FIG. 6 illustrates an enhanced perspective view of a first end of one potential embodiment of a towel-spinning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to spin a rally towel. More specifically, there exists a long-felt need in the art for a towel-spinning device that allows a user to easily spin a rally towel. There also exists a long-felt need in the art for a towel-spinning device that allows a user to easily spin a rally towel without allowing the towel to bunch up or become knotted during use. In addition, there exists a long-felt need in the art for a towel-spinning device that allows a user to spin a rally towel without discomfort and fatigue to the wrist, arm, and shoulder of the user. Finally, there exists a long-felt need in the art for a towel-spinning device that allows a user to spin a rally towel while firmly securing the rally towel.

The present invention, in one exemplary embodiment, is comprised of a towel-spinning device primarily comprised of a first end having at least one removable end cap and a second end that is used as a handle. The body is preferably cylindrical in shape but may have any shape including, but not limited to, a shape that may relate to a team, a mascot, an item, an object, a character, a piece of sporting equipment, etc. The first end of the body is comprised of an opening that receives at least one end cap. The end cap is comprised of a round top surface and a round side wall that can be received by the opening. The top surface of the end cap may be comprised of at least one decorative structure that can include, but is not limited to, a team logo, a team mascot, an item, an object, a character, a person, a player, a coach, an owner, a piece of sporting equipment, a logo, a brand, etc. The decorative structure may be comprised of at least one light source that is preferably an LED light that may illuminate any color and in any illumination pattern.

The second end of the body is used as a handle to hold the device. In one embodiment, the second end may be comprised of at least one grip area. The grip area may be comprised of a raised or recessed texture that improves a user's ability to grip the body.

The device may also be comprised of at least one towel. The towel is preferably rectangular in shape and may be made from any fabric material known in the art. The towel may also be comprised of at least one indicia such as, but not limited to, a team logo, a team mascot, an item, an object, a character, a person, a player, a coach, an owner, a piece of sporting equipment, a logo, a brand, a word, a number, etc.

The device is also comprised of a method of use. First, the end cap is removed from the opening. Then, a portion of the towel is inserted into the opening. Next, the end cap can be re-inserted into the opening to secure the towel to the body by pinning the towel within the body via the end cap. Then, a user can grasp the second end and twirl the device, preferably at a sporting event.

Accordingly, the towel-spinning device of the present invention is particularly advantageous as it provides a towel-spinning device that allows a user to easily spin a rally towel without allowing the towel to bunch up or become knotted during use. In addition, the device allows a user to do so without discomfort and fatigue to the wrist, arm, and shoulder of the user. Finally, the device allows a user to spin a rally towel while firmly securing the rally towel. In this manner, the towel-spinning device overcomes the limitations of existing methods of spinning and using rally towels known in the art.

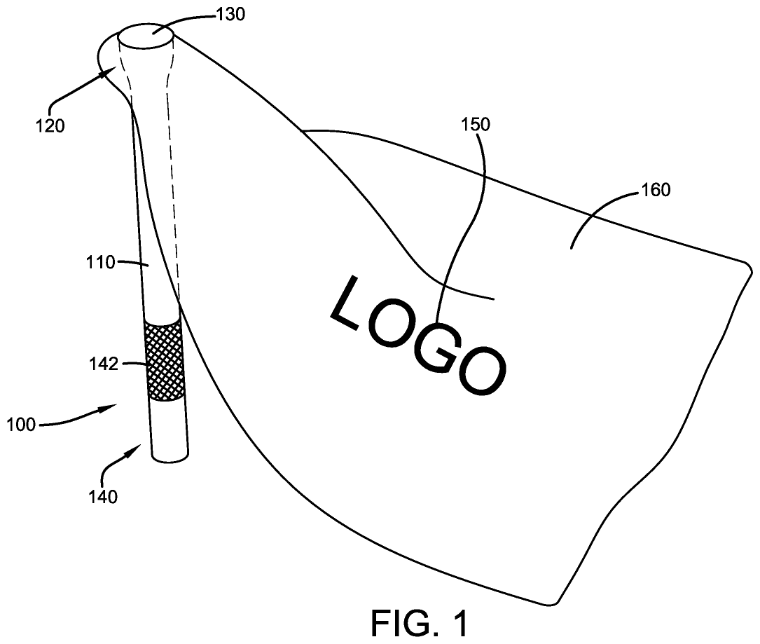

Referring initially to the drawings, FIG. 1 illustrates a perspective view of one potential embodiment of a towel-spinning device 100 of the present invention in accordance with the disclosed architecture. The device 100 is primarily comprised of body 110 with a first end 120 comprised of at least one removable end cap 130 and a second end 140 used as a handle. The device 100 and all components are preferably made from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The device 100 and all components may be any color in the art. The device 100 may also have at least one indicia 150 such as, but not limited to, patterns, logos, emblems, images, symbols, designs, letters, numbers, words, characters, animals, advertisements, brands, etc. The body 110 is preferably cylindrical in shape. However, the body 110 may have any shape. Said shape may relate to a team, a mascot, an item, an object, a character, a piece of sporting equipment, etc.

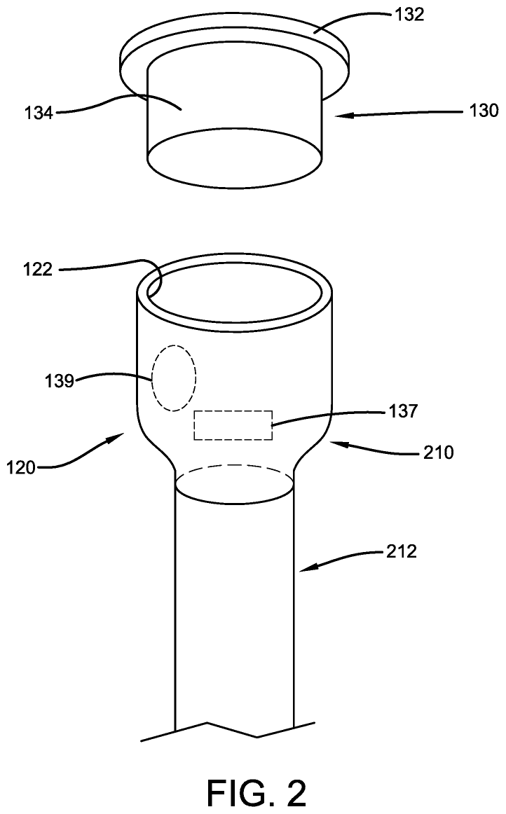

The first end 120 of the body 110 is comprised of an opening 122, as best seen in FIG. 2. The opening 122 receives at least one end cap 130. The end cap 130 is comprised of a round top surface 132 and a round side wall 134 that can be received by the opening 122.

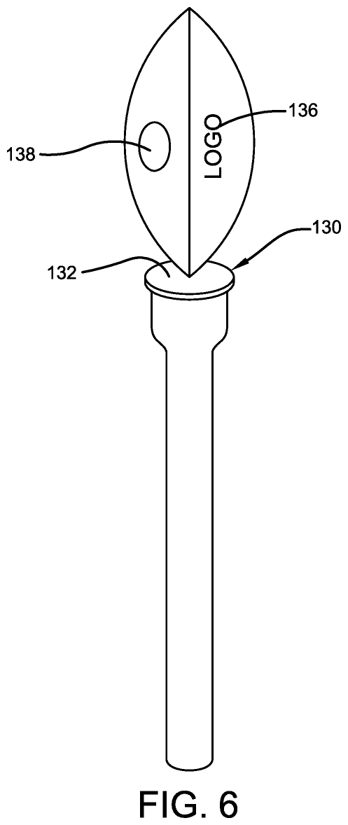

The top surface 132 of the end cap 130 may be comprised of at least one decorative structure 136, as seen in FIG. 6. The structure 136 can include, but is not limited to, a team logo, a team mascot, an item, an object, a character, a person, a player, a coach, an owner, a piece of sporting equipment, a logo, a brand, etc.

In one embodiment, the structure 136 is comprised of at least one light source 138, as seen in FIG. 6. The light source 138 is preferably an LED light that may illuminate any color and in any illumination pattern. The light source 138 is preferably activated by at least one motion sensor 139 within the structure 136. In addition, the light source 138 is powered by at least one battery 137 within the structure 136.

The second end 140 of the body 110 is used as a handle to hold the device 100. In one embodiment, the second end 140 is comprised of at least one grip area 142. The grip area 142 may be comprised of a raised or recessed texture that improves a user's ability to grip the body 110. In one embodiment, the grip area 142 may be attached to the body 110 via at least one bearing that allows the grip area 142 to rotate around the body 110 during use.

In one embodiment, the device 100 may also be comprised of at least one towel 160. The towel 160 is preferably rectangular in shape but may be any shape, including but not limited to jersey shaped. The towel 160 may be made from any fabric material known in the art. The towel 160 may be made of a reflective material in one embodiment for night-time use. The towel 160 may also be comprised of at least one indicia 150 such as, but not limited to, a team logo, a team mascot, an item, an object, a character, a person, a player, a coach, an owner, a piece of sporting equipment, a logo, a brand, a word, a number, etc.

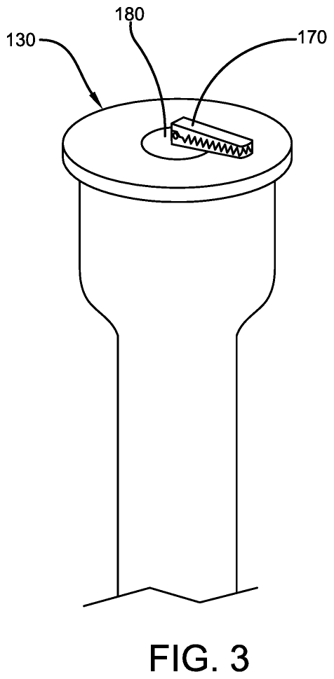

In another embodiment, the end cap 130 is fixedly attached to the body 110. In this embodiment, the end cap 130 is comprised of at least one fastener 170 and at least one rotation point 180. The rotation point 180 may be a rotating pin, a pivot pin, a rotating bearing, etc., or any other structure that rotates 360 degrees, as seen in FIG. 3. The fastener 170 is positioned on the rotation point 180. The fastener 170 is preferably (but not limited to) a clip. In this embodiment, the clip 170 can be used to temporarily secure the towel 160 to the device 100 and allows a user to easily spin the towel 160 via the rotation point 180 while moving the body 110 in a circular motion.

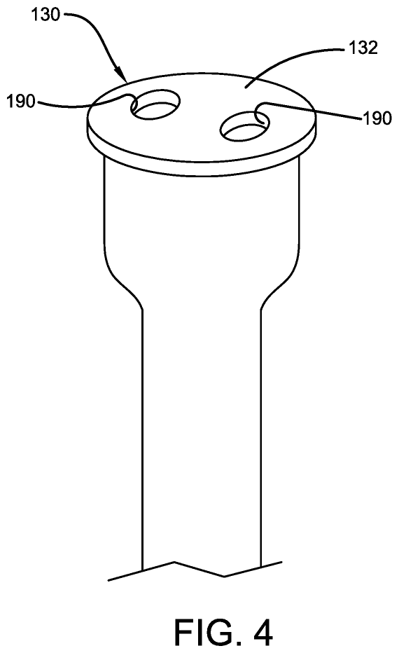

In a further embodiment, the end cap 130 may be comprised of at least two openings 190, as seen in FIG. 4. This allows the towel 160 to be fed through the openings 190 and through the end cap 130. In this manner, the towel 160 is secured to the device 100.

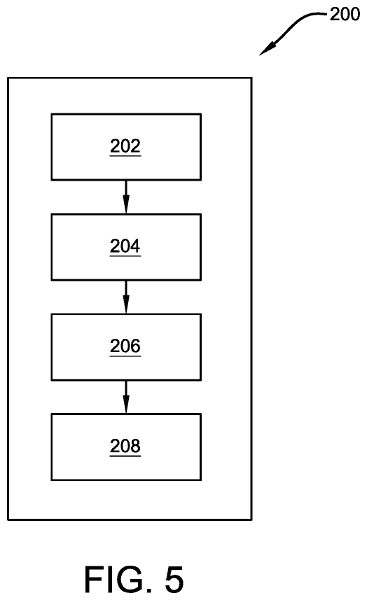

FIG. 5 illustrates a flowchart of a method of using 200 one potential embodiment of a towel-spinning device 100 of the present invention in accordance with the disclosed architecture. The device 100 is also comprised of a method of use 200. First, the end cap 130 is removed from the opening 122 [Step 202]. Then, a portion of the towel 160 is inserted into the opening 122 [Step 204 ]. Next, the end cap 130 can be re-inserted into the opening 122 to secure the towel 160 to the body 110 by pinning the towel 160 within the body via the end cap 130 [Step 206]. Then, a user can grasp the second end 140 and twirl the device 100, preferably at a sporting event [Step 208]. Other methods for other embodiments of the device 100 may involve placing the towel 160 through the openings 190 or placing the towel 160 into the fastener 170.

In one embodiment, the body 110 may be of a two-piece construction, wherein a first part 210 of the body rotates 360 degrees within a second part 212 of the body 110

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “towel-spinning device” and “device” are interchangeable and refer to the towel-spinning device 100 of the present invention.

Notwithstanding the foregoing, the towel-spinning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the towel-spinning device 100 as shown in the FIGS. are for illustrative purposes only, and that many other sizes and shapes of the towel-spinning device 100 are well within the scope of the present disclosure. Although the dimensions of the towel-spinning device 100 are important design parameters for user convenience, the towel-spinning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A towel-spinning device comprising:
a body comprised of an opening; and
an end cap.

2. The towel-spinning device of claim 1, wherein the body is comprised of a mascot shape, an item shape, an object shape, a character shape, or a piece of sporting equipment shape.

3. The towel-spinning device of claim 1, wherein the end cap is comprised of a decorative element.

4. The towel-spinning device of claim 1, wherein the decorative element is comprised of a team logo, a team mascot, an item, an object, a character, a person, a player, a coach, an owner, a piece of sporting equipment, a logo, or a brand.

5. The towel-spinning device of claim 1 further comprised of a light source.

6. The towel-spinning device of claim 5, wherein the light source is activated by a motion sensor.

7. The towel-spinning device of claim 5, wherein the light source is comprised of an LED light.

8. The towel-spinning device of claim 5, wherein the light source is powered by a battery.

9. A towel-spinning device comprising:
a body comprised of an end cap having a first opening and a second opening; and
a towel.

10. The towel-spinning device of claim 9, wherein the body is comprised of a grip area.

11. The towel-spinning device of claim 9, wherein the grip area is comprised of a raised or a recessed texture.

12. A towel-spinning device comprising:
a body comprised of an end cap, the end cap comprised of a fastener and a rotation point; and
a towel.

13. The towel-spinning device of claim 12, wherein the fastener is comprised of a clip.

14. The towel-spinning device of claim 13, wherein the clip is positioned on the rotation point.

15. The towel-spinning device of claim 13, wherein the clip can rotate 360 degrees around the rotation point.

16. The towel-spinning device of claim 12, wherein the towel is comprised of a rectangular shape.

17. The towel-spinning device of claim 12, wherein the towel is comprised of an indicia.

18. The towel-spinning device of claim 17, wherein the indicia is comprised of a team logo, a team mascot, an item, an object, a character, a person, a player, a coach, an owner, a piece of sporting equipment, a logo, a brand, a word, or a number.

19. The towel-spinning device of claim 12, wherein the towel is comprised of a reflective material.

20. The towel-spinning device of claim 12, wherein the towel is comprised of a fabric material.
